(19) United States
(12) Patent Application Publication
(10) Pub. No.: US 2009/0063321 A1
(43) Pub. Date: Mar. 5, 2009

(54) Alaskan auto trust

(76) Inventor: Edward J. McCarthy, University City, MO (US)

Correspondence Address: Edward J. McCarthy, 928 North McKnight Rd., University City, MO, 63132, US

(21) Appl. No.: 12/157,307

(22) Filed: Jun. 9, 2008

Related U.S. Application Data
(60) Provisional application No. 60/934,757, filed on Jun. 15, 2007.

(51) Int. Cl. G06Q 40/00

(52) U.S. Cl. 705/35

(57) ABSTRACT

The purpose of this invention is to limit the liability of an automobile owner, and to provide a method for securely storing title to automobiles. In order to limit the liability of the automobile owner, the vehicle is placed in a trust. In addition, by placing the vehicle in a trust, the owner is allowed to choose the taxing jurisdiction of the vehicle. The grantor of the Auto Trust can reduce the risk of losing title to the vehicle by housing all titles held in a trust at a centralized, secure, and remote location.

### CROSS-REFERENCE TO RELATED APPLICATIONS

None

### STATEMENT REGARDING FEDERALLY SPONSORED RESEARCH

Not Applicable.

### BACKGROUND OF THE INVENTION

1. Field of the Invention

The present invention is, briefly, a method for securely storing title to automobiles and limiting liability associated with the ownership of automobile.

2. Related Art

From the point of view of an automobile owner, today's America is a place fraught with the danger of litigation. Be it a slow Sunday drive or a late night trip down a wooded road, the liability risk that burdens automobile owners is excessively high. To say that one can always ensure against an accident is not realistic. Primarily, insurance has mitigated liability for auto accidents, but risk still exist for owners. This risk provided the impetus for innovation to be detailed later.

Citizen's democracy has failed to limit state jurisdictions from increasing taxation on personal property year after year. The main problem with the taxation of automobiles lies in the fact that taxation is higher on new cars than on depreciated older cars. This feature of taxation creates an incentive to keep ownership of more dangerous, less fuel efficient, and more repair prone vehicles. Instead of making our automobiles safer, cleaner, and cheaper, such taxation limits the possible improvements developed by the automobile industry. To allow greater implementation of innovations provided by the automobile industry, the heavy burden of taxation must be mitigated. The only way to legally avoid such taxation is to use friendlier tax jurisdictions.

Ownership recording is still haphazard and non-uniform. A simple sheet of paper is all that records the owner's claim to an automobile. A title is small, fragile and easily lost. To eliminate the risk of loss of a title, a centralized, secure and remote place of filing would be more advantageous. Though a bank deposit box is available for the purpose of safe keeping, it doesn't offer the advantages of our method. Coupled with advantages outlined above, this feature provides a great shelter in which to store one's title.

### SUMMARY OF THE INVENTION

The invention is, generally, the ability to encapsulate an automobile in a trust shell and limit liability and place ownership in any jurisdiction.

To limit the liability of an automobile owner, the solution is to place the vehicle in a trust. Thus, by having the vehicle held in a trust, the liability of ownership is mitigated. An accident caused by an operator of the vehicle would limit liability to the Auto Trust.

To limit the taxation of vehicles, placing the automobile in a trust would allow one to choose the tax jurisdiction in which the vehicle would be taxed. In essence, the citizen would be able to choose the best tax jurisdiction available without having to be resident of that jurisdiction. This reduction in taxes would allow the owner to make less inhibited decisions with regard to the purchase of a new automobile, thus affording the owner of all advantages of innovation, safety, and efficiency. After the creation of a trust for an individual, the criterion of the tax minimization would be reduced in importance when purchasing the new vehicle.

To decrease the risk of loss of physical title, a nation-wide system of title storage needs to be developed. By housing all titles held in a trust at a centralized, secure, and remote location the grantor of the Auto Trust can mitigate the risks of loss of title.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 is a schematic representation of the automobile trust method described and claimed herein.

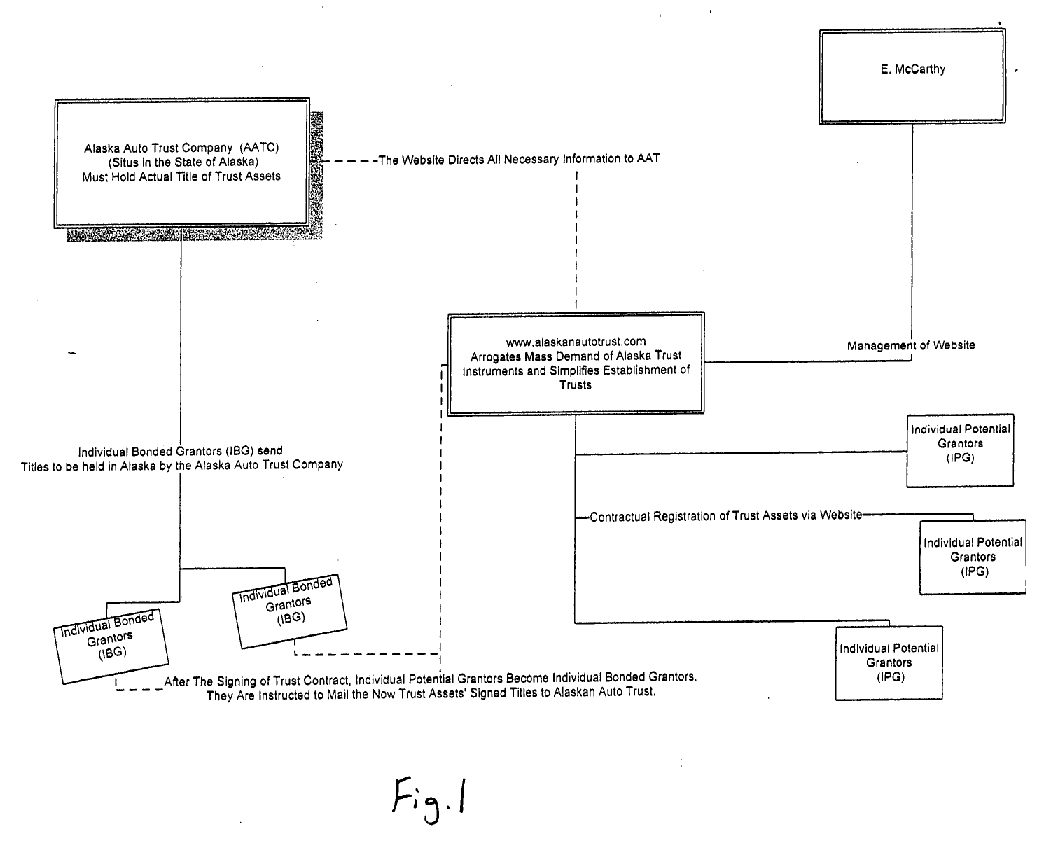

### DETAILED DESCRIPTION OF THE PREFERRED EMBODIMENTS

The following description of the preferred embodiment(s) is merely exemplary in nature and is in not way intended to limit the invention, its application, or uses.

Step One: An Individual Potential Grantor (IPG) visits our websites, http://www.alaskanautotrustcompany.com or http:/www.alaskaautotrustcompany.com, and creates a user account for the express purpose of creating a trust. Here are the specific web pages we are using; however, the name is independent of the concept or process.

Step Two: The IPG determines if the trust vehicle for the grantor's needs. If the IPG decided to hold in trust the automobile, then the IPG fills out the required information to be inserted into the trust contract. The following is the information required:

GRANTOR—Personal contact information including address information, Social Security number, date of birth, email address, and driver license number.

CONTACT—An emergency contact; their address and phone numbers

BENEFICIARY—Either an individual or a charitable organization. Beneficiaries that are not charitable organizations must provide a social security number.

VEHICLE—Vehicle's information. MUST have the Vehicle's VIN (Vehicle Identification Number) to complete the process

INSURANCE—Vehicle's insurance information; insurance carrier, policy number, policy start and expiration dates, agent's name and contact information.

Step Three: The IPG by signing the online contract to form a trust obligates the trust company to hold in trust the trust assets so named in the above section. The IPG becomes an Individual Bonded Grantor (IBG). Additionally, the trust assets can be amended in the future since they are managed online.

Step Four: The title documents are sent by the now IBG to the Trust Company so that the trust may be legally formed in the trust jurisdiction. The title is held in a centralized, secure and remote location set forth in the legal documents of the trust.

The main feature afforded by this system is the nation-wide systemization of vehicle record keeping and registration. By allowing individuals to place automobile titles in trust, managed by a trust company, this system reduces the risks and problems outlined in Section 1 of this document. The difficulty of arranging a trust in a jurisdiction for the purpose of a tax reduction, safe storage and liability limitation is compounded by the cost and time needed for each individual to locate, setup, and maintain such trust. Our website aggregates that demand and facilitates a resolution. The time and money saved by the grantor allows that individual to use such time and money as they see fit. It allows all U.S. citizens the opportunity to choose their tax jurisdiction of trust assets for the purpose of tax minimization, and it allows them to do so at a lower cost.

As various modifications could be made to the exemplary embodiments, as described above with references to the corresponding illustrations, without departing from the scope of the inventions, it is intended that all matter contained in the foregoing description and shown in the accompanying drawings shall be interpreted as illustrative rather then limiting. Thus the breadth and scope of the present invention should not be limited by any of the above-described exemplary embodiments, but should be defined only in accordance with the following claims appended hereto and their equivalents.

What is claimed is:

1. A method of storing title to an automobile and limiting liability associated with ownership thereof as described and shown herein.
